(19) United States
(12) Patent Application Publication
(10) Pub. No.: US 2011/0051729 A1
(43) Pub. Date: Mar. 3, 2011

(54) METHODS AND APPARATUSES RELATING TO PSEUDO RANDOM NETWORK CODING DESIGN

(75) Inventors: Hung-Yu Wei, Taipei City (TW); Cheng-Chih Chao, Fengyuan City (TW); Ching-Chun Chou, Taipei City (TW)

(73) Assignee: Industrial Technology Research Institute and National Taiwan University

(21) Appl. No.: 12/731,438

(22) Filed: Mar. 25, 2010

Related U.S. Application Data
(60) Provisional application No. 61/237,832, filed on Aug. 28, 2009.

(51) Int. Cl. H04L 12/56

(52) U.S. Cl. 370/392

(57) ABSTRACT

A method of providing a pseudo random network coding design may include receiving, at a receiver node, signaling including an index of a codebook communicated from a transmitter node employing network coding, utilizing the codebook associated with the index to generate a coding coefficient used to employ the network coding, and decoding the signaling using the coding coefficient. A corresponding apparatus is also provided.

Another method of providing a pseudo random network coding design may include utilizing a coding coefficient for network coding of signaling to be sent from a transmitter node to a receiver node, the coding coefficient corresponding to a codebook accessible to the transmitter node, and communicating the signaling to the receiver node along with an index of the codebook to enable the receiver node to generate the coding coefficient using a locally stored codebook selected based on the index. A corresponding apparatus is also provided.

### CROSS REFERENCE TO RELATED APPLICATION

This application claims the benefit of U.S. Provisional Application No. 61/237,832, filed Aug. 28, 2009, the content of which is incorporated herein in its entirety.

### TECHNOLOGICAL FIELD

Embodiments of the present application relate generally to communication technology and, more particularly, relate to an apparatus, method and a system for providing network coding design.

### BACKGROUND

In order to provide easier or faster information transfer and convenience, telecommunication industry service providers are continually developing improvements to existing networks. Network coding is a transmission paradigm that has been developed as a potential mechanism by which to improve the overall throughput of wireless networks such as, for example, wireless networks that employ broadcast transmissions. Existing network coding schemes typically require an information exchange among neighboring nodes in order to enable the nodes to correctly encode and decode the transmitted data packets. Random linear network coding and XOR network coding are some examples of network coding mechanisms that may be employed.

Network coding typically involves the encoding of a particular packet using a corresponding coding coefficient. Thus, the information exchange described above may include an identification of the coding coefficient used in connection with encoding the corresponding transmitted packets. The coding coefficients are often randomly generated values. Conventional network coding mechanisms typically put information descriptive of the coding coefficients in the packet header. Inclusion of the coding coefficients in the packet header, however, may increase system overhead and may result in inefficient coding. Thus, system performance may be reduced.

### BRIEF SUMMARY

In view of the foregoing, example embodiments of the present application are therefore directed to a mechanism for providing network coding that does not significantly increase overhead and therefore may increase coding efficiency. For example, some embodiments may provide for the inclusion of an index in the packet header instead of the coding coefficients. The index may be used to identify a codebook to be used for generation of the coding coefficients. Accordingly, by providing codebooks at transmitting and receiving nodes and a mechanism by which to identify the codebook used for encoding and therefore also to be used for decoding at the receiving side, embodiments of the present application may enable effective coding with less overhead since the index, which is smaller than the coding coefficients themselves, may be communicated instead of actually communicating the coding coefficients.

In an exemplary embodiment, a method of providing a pseudo random network coding design is provided (“exemplary” as used herein referring to “serving as an example, instance or illustration”). The method may include receiving, at a receiver node, signaling including an index of a codebook communicated from a transmitter node employing network coding, utilizing the codebook associated with the index to generate a coding coefficient used to employ the network coding, and decoding the signaling using the coding coefficient.

In another exemplary embodiment, an apparatus for providing a pseudo random network coding design is provided. The apparatus may include a processor. The processor may be configured to receive, at a receiver node, signaling including an index of a codebook communicated from a transmitter node employing network coding, utilize the codebook associated with the index to generate a coding coefficient used to employ the network coding, and decode the signaling using the coding coefficient.

In an exemplary embodiment, another apparatus for providing a pseudo random network coding design is provided. The apparatus may include a processor. The processor may be configured to utilize a coding coefficient for network coding of signaling to be sent from a transmitter node to a receiver node, the coding coefficient corresponding to a codebook accessible to the transmitter node, and communicate the signaling to the receiver node along with an index of the codebook to enable the receiver node to generate the coding coefficient using a locally stored codebook selected based on the index.

In another exemplary embodiment, another method for providing a pseudo random network coding design is provided. The method may include utilizing a coding coefficient for network coding of signaling to be sent from a transmitter node to a receiver node, the coding coefficient corresponding to a codebook accessible to the transmitter node, and communicating the signaling to the receiver node along with an index of the codebook to enable the receiver node to generate the coding coefficient using a locally stored codebook selected based on the index.

### BRIEF DESCRIPTION OF THE SEVERAL VIEWS OF THE DRAWING(S)

Having thus described the application in general terms, reference will now be made to the accompanying drawings, which are not necessarily drawn to scale, and wherein:

FIG. 1 illustrates a system in which exemplary embodiments of the present application may be practiced;

FIG. 2 illustrates an apparatus for providing a pseudo random network coding design according to exemplary embodiments of the present application;

FIG. 3 illustrates a structure of a packet header that may be generated according to exemplary embodiments of the present application;

FIG. 4 illustrates a codebook from which N+T coding coefficients may be generated according to an exemplary embodiment of the present application;

FIG. 5 illustrates another codebook from which N+T coding coefficients may be generated according to an exemplary embodiment of the present application;

FIG. 6 illustrates still another codebook from which N+T coding coefficients may be generated according to an exemplary embodiment of the present application;

FIG. 7 illustrates a codebook including linear redundancy according to another exemplary embodiment of the present application;

FIG. 8 illustrates a codebook in which only a redundancy part makes up the codebook according to an exemplary embodiment of the present application;

FIG. 9 is a flowchart including various steps in a method for providing a pseudo random network coding design according to an exemplary embodiment of the present application; and

FIG. 10 is a flowchart including various steps in method for providing a pseudo random network coding design according to another exemplary embodiment of the present application.

### DETAILED DESCRIPTION

Some embodiments of the present application will now be described more fully hereinafter with reference to the accompanying drawings, in which some, but not all embodiments of the application are shown. Indeed, various embodiments of the application may be embodied in many different forms and should not be construed as limited to the embodiments set forth herein; rather, these embodiments are provided so that this disclosure will satisfy applicable legal requirements. Like reference numerals refer to like elements throughout.

As indicated above, network coding designs typically have a relatively large amount of information in packet headers. This information, which may include a network coding coefficient, may lead to relatively inefficient coding due to increased overhead. Some embodiments of the present application may provide for a reduction in overhead and therefore increased coding efficiency. As such, some embodiments of the present application may improve system performance.

In order to reduce overhead, some embodiments of the present application may employ a coding mechanism in which an index indicative of a codebook may be included in the packet header instead of the network coding coefficient. Given the index, the coefficient may be locally generated by a device receiving the index. The index may be smaller than the coefficient, and as the coefficient may be locally generated based on the index, packet header overhead may be reduced. The codebooks themselves may be locally stored at each device and may be pre-programmed or pre-stored, and may be updateable. Some embodiments may also provide for a reduced header structure for pseudo-random network coding.

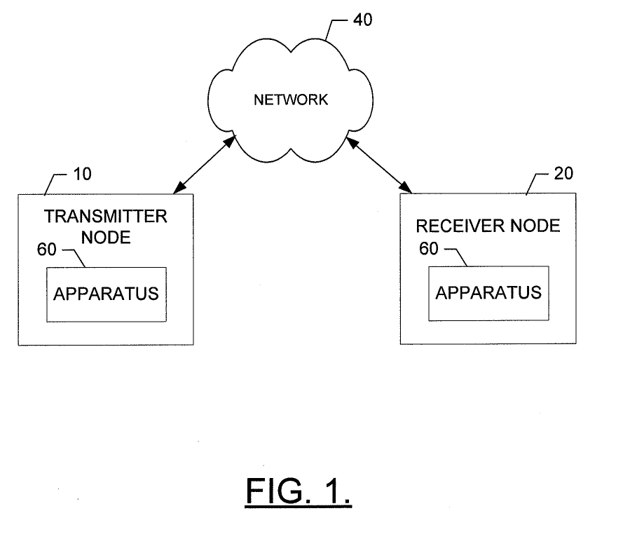

In an exemplary embodiment, nodes operating within a pseudo-random network may employ an apparatus configured to perform functions associated with managing or controlling operations described herein relative to network coding. Thus, for example, each respective node may employ an example embodiment of the present application. A simplistic illustration of a system in which an exemplary embodiment of the present application may be practiced is shown in FIG. 1. FIG. 1 illustrates a transmitter node 10 and a receiver node 20 that are configured to communicate with each other via a network 40. The network 40 may be any wireless communication network that employs network coding. In some cases, the network 40 may be a network employing wireless broadcast retransmission with network coding in association with enhanced multicast-broadcast service (E-MBS) or another network performing broadcast transmissions.

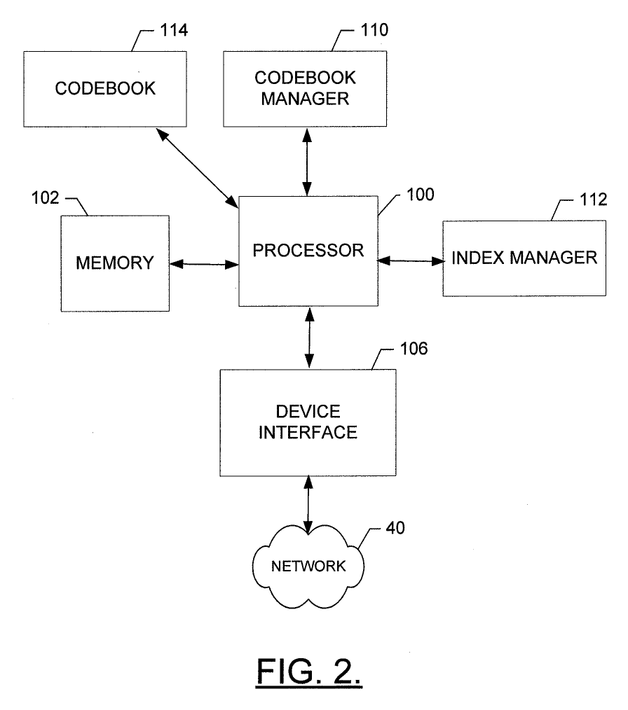

As shown in FIG. 1, the transmitter node 10 and the receiver node 20 may each include an apparatus 60 according to an example embodiment, the apparatus being described in greater detail below in connection with the description of FIG. 2. At the transmitter node 10, the apparatus 60 may be configured to enable the transmitter node 10 to define an index in the packet header of data sent to the receiver node 20. At the receiver node 20, the apparatus 60 may be configured to generate a network coding coefficient based on the index received from the transmitter node 10.

FIG. 2 illustrates an example of the apparatus 60 according to an exemplary embodiment. Since the embodiment of FIG. 1 provides for both the transmitter node 10 and the receiver node 20 to include the apparatus 60, and the apparatus 60 of FIG. 2 includes both receiver side coefficient generation circuitry and transmitter side index generation circuitry, the transmitter node 10 and the receiver node 20 may be enabled to switch roles (i.e., the receiver node 20 may transmit to another node) if desired. However, in some embodiments, the receiver node 20 may include receiver-side coefficient generation circuitry without transmitter-side index generation circuitry, and the transmitter node 10 may only include transmitter-side index generation circuitry without receiver-side coefficient generation circuitry.

Referring now to FIG. 2, the apparatus 60 may include or otherwise be in communication with a processor 100, a memory 102, and a device interface 106. The memory 102 may include, for example, volatile and/or non-volatile memory (i.e., non-transitory storage medium or media) and may be configured to store information, data, applications, instructions or the like for enabling the apparatus 60 to carry out various functions in accordance with exemplary embodiments of the present application. For example, the memory 102 may be configured to buffer input data for processing by the processor 100 and/or store instructions for execution by the processor 100.

The processor 100 may be embodied in a number of different ways. For example, the processor 100 may be embodied as various processing means such as processing circuitry embodied as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 100 may be configured to execute instructions stored in the memory 102 or otherwise accessible to the processor 100.

Meanwhile, the device interface 106 may be any means such as a device or circuitry embodied in either hardware, software, or a combination of hardware and software that is configured to receive and/or transmit data from/to a network and/or any other device or module in communication with the apparatus. In this regard, the device interface 106 may include, for example, an antenna (or multiple antennas) and supporting hardware and/or software for enabling communications with a wireless communication network. In fixed environments, the device interface 106 may alternatively or also support wired communication. As such, the device interface 106 may include a communication modem and/or other hardware/software for supporting communication via cable, digital subscriber line (DSL), universal serial bus (USB) or other mechanisms.

In an exemplary embodiment, the processor 100 may be embodied as, include or otherwise control a codebook manager 110 and an index manager 112. The codebook manager 110 and the index manager 112 may each be any means such as a device or circuitry embodied in hardware, software or a combination of hardware and software (e.g., processor 100 operating under software control) that is configured to perform the corresponding functions of the codebook manager 110 and the index manager 112, respectively, as described below.

In an exemplary embodiment, the codebook manager 110 may operate responsive to execution of instructions, code, modules, applications and/or circuitry for selecting a codebook for use in generating a coding coefficient based on an index. As such, in response to receipt of the index, the codebook manager 110 may be configured to select a portion of a codebook 114 corresponding to the index received. The codebook 114 or portion of the codebook that is selected based on the index received may then be used to identify the coding coefficient used for encoding data.

In an example embodiment, when transmitting data, the codebook manager 110 may be employed to use a selected codebook (e.g., codebook 114) to encode data for transmission using network coding (e.g., XOR coding, Galois Field based linear coding, and/or the like) with a corresponding coding coefficient. The codebook manager 110 may then identify the selected codebook 114 to the index manager 112 to enable the index manager 112 to construct a packet header with an indication of the index of the selected codebook 114. Some examples of codebooks are described in greater detail below.

When receiving data, the codebook manager 110 may utilize the received index to select an appropriate codebook (e.g., codebook 114) and generate the corresponding coding coefficient used to encode the data. The codebook manager 110 may therefore enable decoding of the data using the correct codebook. Notably, however, the coding coefficient itself may not be sent in the transaction described above, thereby reducing the overhead in the packet header of data encoded as described above.

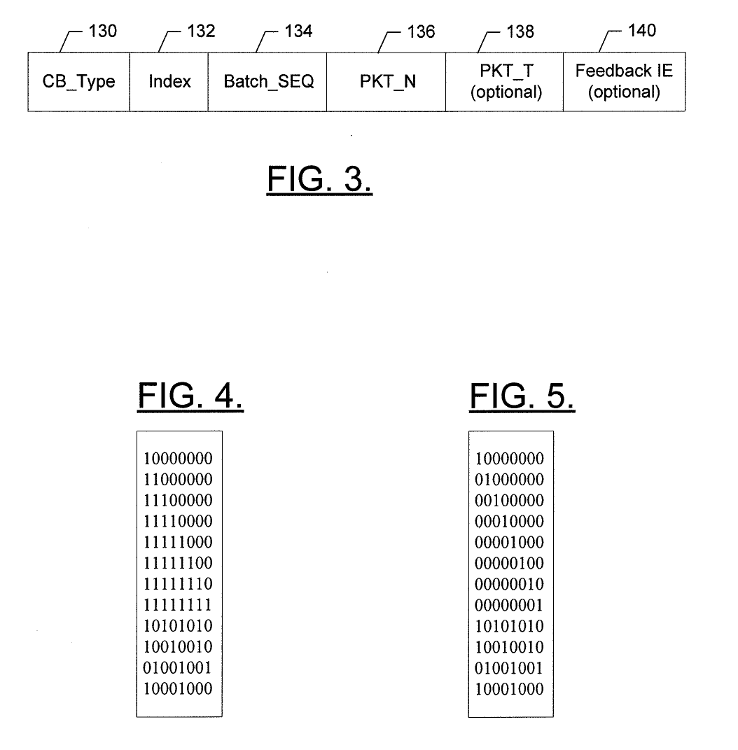

The index manager 112 may be configured to generate a packet header structure according to an exemplary embodiment when operating at the transmitter node 10. However, when operating at the receiver node 20, the index manager 112 may be configured to extract information from the packet header structure generated at the transmitter side. FIG. 3 illustrates an example structure of a packet header that may be generated by the index manager 112 or handled by the index manager 112 dependent upon whether the apparatus 60 is transmitting or receiving coded packets.

As shown in FIG. 3, the packet header structure may include an indication of codebook type (e.g., CB_Type 130) and an indication of the code index 132. The length of the indication of codebook type may depend upon the number of codebooks stored at the apparatus 60. The codebook type specifies the codebook to be used for a particular data transmission. The code index 132 represents the index for coding coefficients under a specific codebook. For example, for a specific codebook given the same number of packets for encoding, N, and redundancy requirement, T, the code index 132 should map to the same coding coefficient. The length of the indication of the code index 132 may depend on the number of rows in a corresponding codebook.

The packet header structure may also include a batch sequence identifier (e.g., Batch_SEQ 134), and an indication of the number of original packets (e.g., PKT_N 136). The batch sequence identifier indicates the head of the packet for encoding. For example, if encoding packets A, B and C using a first codebook and packets D, E and F using a second codebook, the first codebook may encode its respective packets as A, A⊕B, A⊕B⊕C; and the second codebook may encode its respective packets as D⊕E⊕F, E⊕F, F. For the encoded packet D⊕E⊕F, E⊕F, F, the Batch_SEQ may be D. This sequence identifier indicates the same group of packets for encoding and decoding. The batch sequence identifier may have a length that depends on the number of batches in memory, and the indication of the number of original packets may depend on the size of packets for transmission. The coding coefficient may be about equal to the batch size. The number of original packets provides the number of packets for encoding. As such, the number of original packets may provide the least number of coding coefficients to be generated.

In some embodiments, the packet header structure may include additional optional portions such as an indication of batch size (e.g., PKT_T 138) and/or a feedback information element (e.g., Feedback IE 140). The indication of batch size may provide the overall number of actually generated coding coefficients. If no uplink feedback is applied, the batch size may also indicate the actual packet for transmission. The feedback information element may define a feedback threshold for the number of error packets in variable sized batch schemes. A counter may be kept for the number of received error packets. If the number of error packets exceeds the feedback threshold, feedback may be sent for notification to trigger data retransmission. After retransmission, the error counter may be reset to zero. Accordingly, for example, batch size may be varied such that a variable batch size scheme may be supported. In some cases, the feedback threshold may define a termination command to inform destination nodes of the termination on the current network coding batch. In some embodiments, the feedback information element may include a retransmission command to indicate that following information is retransmission information. Other elements may also be included in the feedback information element. However, in some cases, the feedback information element may simply be a one bit flag (e.g., “set” representing feedback presence, or “not set” representing a lack of feedback).

Embodiments of the present application may utilize a codebook that is pre-programmed or pre-stored at both the transmitter node 10 and the receiver node 20 to generate coding coefficients used to encode and decode data transmitted therebetween. However, the coding and decoding may be performed without transmission of the coding coefficients. Instead, the coding coefficient used to encode the data may be generated at the receiving device (i.e., the receiver node 20 based on an index provided in the packet header sent by the transmitter node 10. In such instances, the coding coefficient may be generated based on a specific rule for coding coefficient generation. The specific rule may be used to generate a set of coding coefficients considering the number of packets for encoding and a redundancy requirement. In an example embodiment, when the number of packets for encoding is N and the redundancy requirement is given by T, N+T coding coefficients may be generated. Initially, for example, N coding coefficients may be generated with coding coefficients 0 and 1 for XOR coding or some other encoding scheme. The N coding coefficients may be distinct and may be sufficient to encode N number of packets. If all the packets are successfully received, the packets may be decoded without the other T coding coefficients that were sent since T redundant packets would not be needed.

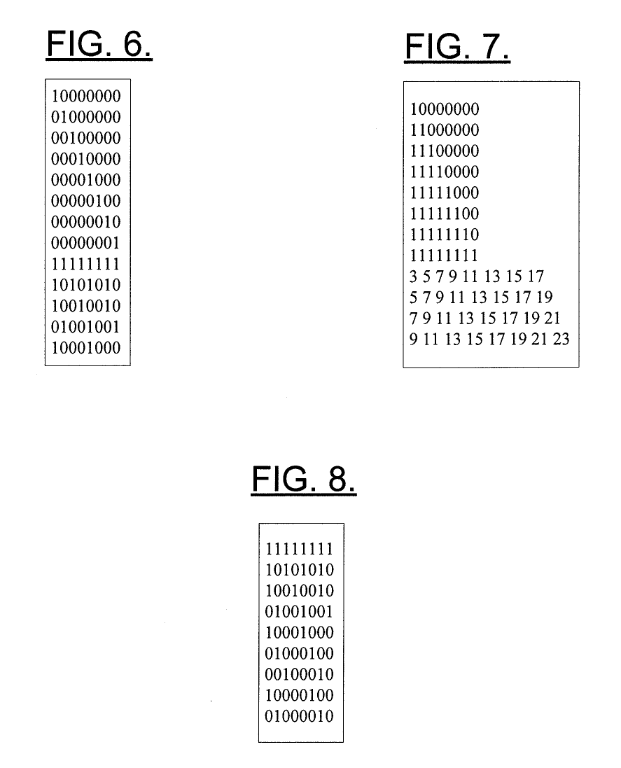

In some examples for N coding coefficients, original packets may be transmitted in the first N packets such that each row of the appropriate codebook contains only one 1, and other entries within each row are 0s. The 1 in each row may indicate a packet encoded in the corresponding sequence using XOR coding. FIG. 4 illustrates an example of this method in rows 1 through 8. As an alternative, triangle-coded packets may be transmitted in the first N packets such that in a given row (e.g., row i) of the appropriate codebook, packet 1 to packet i may each be encoded as shown in rows 1 through 8 of FIG. 5. Rows 9 through 12 of both FIGS. 4 and 5 may be redundant coefficients that may be used for decoding packets not initially successfully received. As such, after initially generating N coding coefficients, T redundant coding coefficients may be generated. In the examples of FIGS. 4 and 5, N=8 and T=4. FIG. 6 illustrates another example codebook in which N=8 and T=5. As can be seen from the 9th row of the codebook of FIG. 6, in some cases, all packets may be XOR encoded in the redundancy portion.

In an example embodiment, the redundant coding coefficients may be 0, 1 or some other coding coefficient setting under a given coding field. For example, for XOR coding redundancy, the idea of congruence may be applied. As such, if packets for encoding are labeled P1 to PN, for each Pi, i=1˜N, packets with the same congruence modular may be encoded using XOR coding. Different modulo may be applied for encoding. For example, mod 2 and mod 3 may be used in an example in which XOR encoding is performed on a packet with P2a+1 under mod 2, P3b+1 and P3b+2 under mod 3. As such, P1⊕P3⊕P5⊕ . . . ⊕P2k+1 may be encoded in mod 2 with 2k+1<N; and P1⊕P4⊕P7⊕ . . . ⊕P3x+1 with 3x+1<N, and P1⊕P5⊕P8⊕ . . . ⊕P3y+2 with 3y+2<N, may be encoded in mod 3. In this example, modulo 0 may be used only once in one codebook. For linear redundancy, a formula for the coding coefficient may also be specified. The formula may generate the same coding coefficients given the same N and T. As such, the same codebook index should map to the same coding coefficients under the same codebook. FIG. 7 illustrates an example codebook including linear redundancy. In the example of FIG. 7, the first 8 rows may be structured as indicated above in the example of FIG. 5. However, the redundancy portion (i.e., rows 9 through 12) may include a set of linear equations defining a redundancy portion that may include symbols other than simply 0s and 1s.

In some example embodiments, only the redundancy part may be applied, which is the generation method for encoding T packets. In such examples, T may be greater than or equal to the number of packets for encoding. In other words, T coding coefficients may be generated using the mechanism described above for N packets when T≧N. FIG. 8 illustrates an example codebook in which only the redundancy part makes up the codebook. Thus, it should be appreciated that in FIG. 8, T≧N.

Accordingly, as indicated in the examples described above, some embodiments of the present application may enable pseudo-random coding coefficient generation based on codebooks that are accessible at the transmitter node 10 and the receiver node 20. The codebooks may be pre-programmed or pre-stored, and may be updateable. Thus, for example, in some cases the codebooks may be loaded before the device is sold to or possessed by the user, but may be updateable at periodic or random intervals thereafter. However, in other cases, the user may upgrade or otherwise access codebooks periodically during operation in order to secure communications. Each codebook may therefore define a collection of coding coefficients that may be identified by an index. The index may be transmitted between nodes rather than transmitting the coding coefficients themselves. Accordingly, packet header size and system overhead may be reduced. Embodiments of the present application may also provide increased system flexibility by enabling use of variable batch sizes. Accordingly, some embodiments may have relatively high resilience with respect to packet errors.

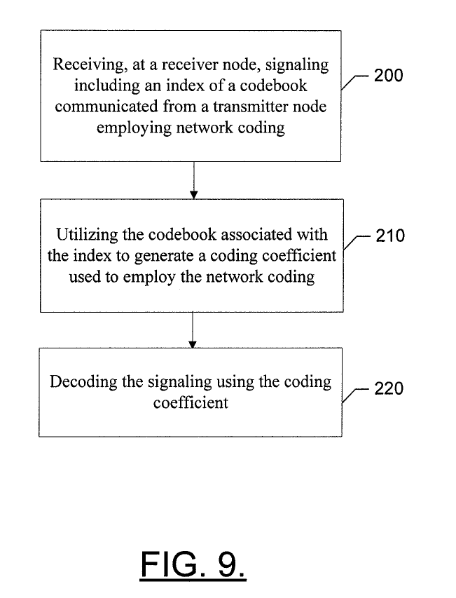

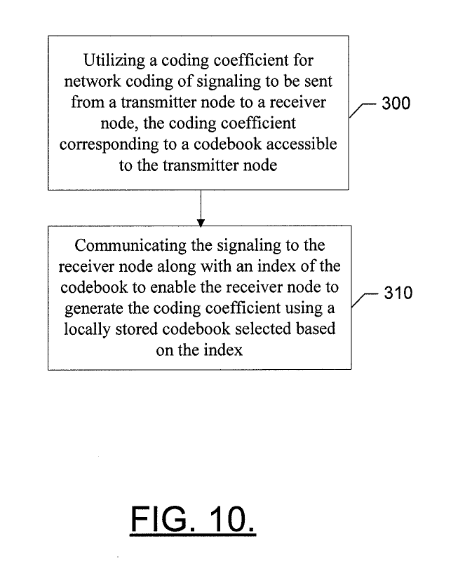

FIGS. 9 and 10 are flowcharts of a system, method and program product according to exemplary embodiments of the application. It will be understood that each block of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory and executed by a processor. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s). These computer program instructions may also be stored in a computer-readable electronic storage memory that can direct a computer or other programmable apparatus to function in a particular manner, such that the instructions stored in the computer-readable memory produce an article of manufacture including instruction means which implement the function specified in the flowcharts block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts block(s).

Accordingly, blocks of the flowcharts support combinations of means for performing the specified functions, combinations of operations for performing the specified functions and program instruction means for performing the specified functions. It will also be understood that one or more blocks of the flowcharts, and combinations of blocks in the flowcharts, can be implemented by special purpose hardware-based computer systems which perform the specified functions or operations, or combinations of special purpose hardware and computer instructions.

In this regard, one embodiment of a method for providing pseudo random network coding design as provided in FIG. 9 may include receiving, at a receiver node, signaling including an index of a codebook communicated from a transmitter node employing network coding at operation 200, utilizing the codebook associated with the index to generate a coding coefficient used to employ the network coding at operation 210, and decoding the signaling using the coding coefficient at operation 220.

In some embodiments, certain ones of the operations above may be modified or further amplified as described below. It should be appreciated that each of the modifications or amplifications below may be included with the operations above either alone or in combination with any others among the features described herein. In this regard, for example, receiving the signaling may include receiving a packet header that includes the index and does not include the coding coefficient. In some cases, receiving the packet header includes receiving the packet header including an indication of batch size, an indication of a feedback threshold defining a threshold number of error packets, or an indication of a termination for a current network coding batch. In an example embodiment, utilizing the codebook may include generating the coding coefficient according to a rule for generating a number of coding coefficients at least equal to a number of packets encoded. In some cases, generating the coding coefficients may include generating additional coefficients for redundancy.

In an exemplary embodiment, an apparatus for performing the method of FIG. 9 above may comprise a processor (e.g., the processor 100) configured to perform some or each of the operations (200-220) described above. The processor may, for example, be configured to perform the operations (200-220) by performing hardware implemented logical functions, executing stored instructions, or executing algorithms for performing each of the operations.

In another example embodiment, a method for providing pseudo random network coding design as provided in FIG. 10 may include utilizing a coding coefficient for network coding of signaling to be sent from a transmitter node to a receiver node, the coding coefficient corresponding to a codebook accessible to the transmitter node at operation 300, and communicating the signaling to the receiver node along with an index of the codebook to enable the receiver node to generate the coding coefficient using a locally stored codebook selected based on the index at operation 310.

In some embodiments, certain ones of the operations above may be modified or further amplified as described below. It should be appreciated that each of the modifications or amplifications below may be included with the operations above either alone or in combination with any others among the features described herein. In this regard, for example, communicating the signaling may include generating a packet header that includes the index and does not include the coding coefficient. In some embodiments, generating the packet header may include generating the packet header including an indication of batch size, an indication of a feedback threshold defining a threshold number of error packets, or an indication of a termination for a current network coding batch. In some embodiments, the codebook includes a number of coding coefficients at least equal to a number of packets encoded and/or a number of coefficients for redundancy.

In an exemplary embodiment, an apparatus for performing the method of FIG. 10 above may comprise a processor (e.g., the processor 100) configured to perform some or each of the operations (300-310) described above. The processor may, for example, be configured to perform the operations (300-310) by performing hardware implemented logical functions, executing stored instructions, or executing algorithms for performing each of the operations.

Many modifications and other embodiments of the applications set forth herein will come to mind to one skilled in the art to which these applications pertain having the benefit of the teachings presented in the foregoing descriptions and the associated drawings. Therefore, it is to be understood that the applications are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, at a receiver node, signaling including an index of a codebook, the signaling being communicated from a transmitter node employing network coding;
utilizing the codebook associated with the index to generate a coding coefficient used to employ the network coding; and
decoding the signaling using the coding coefficient.

2. The method of claim 1, wherein receiving the signaling comprises receiving a packet header that includes the index and does not include the coding coefficient.

3. The method of claim 2, wherein receiving the packet header comprises receiving the packet header including an indication of batch size.

4. The method of claim 2, wherein receiving the packet header comprises receiving the packet header including an indication of a feedback threshold defining a threshold number of error packets.

5. The method of claim 2, wherein receiving the packet header comprises receiving the packet header including an indication of a termination for a current network coding batch.

6. The method of claim 1, wherein utilizing the codebook comprises generating the coding coefficient according to a rule for generating a number of coding coefficients at least equal to a number of packets encoded.

7. The method of claim 6, wherein generating the coding coefficients comprises generating additional coefficients for redundancy.

8. An apparatus comprising a processor configured to:
receive, at a receiver node, signaling including an index of a codebook, the signaling being communicated from a transmitter node employing network coding;
utilize the codebook associated with the index to generate a coding coefficient used to employ the network coding; and
decode the signaling using the coding coefficient.

9. The apparatus of claim 8, wherein the processor being configured to receive the signaling comprises the processor being configured to receive a packet header that includes the index and does not include the coding coefficient.

10. The apparatus of claim 9, wherein the processor being configured to receive the packet header comprises the processor being configured to receive the packet header including an indication of batch size.

11. The apparatus of claim 9, wherein the processor being configured to receive the packet header comprises the processor being configured to receive the packet header including an indication of a feedback threshold defining a threshold number of error packets.

12. The apparatus of claim 9, wherein the processor being configured to receive the packet header comprises the processor being configured to receive the packet header including an indication of a termination for a current network coding batch.

13. The apparatus of claim 8, wherein the processor being configured to utilize the codebook comprises the processor being configured to generate the coding coefficient according to a rule for generating a number of coding coefficients at least equal to a number of packets encoded.

14. The apparatus of claim 13, wherein the processor being configured to generate the coding coefficients comprises the processor being configured to generate additional coefficients for redundancy.

15. A method comprising:
utilizing a coding coefficient for network coding of signaling to be sent from a transmitter node to a receiver node, the coding coefficient corresponding to a codebook accessible to the transmitter node; and
communicating the signaling to the receiver node along with an index of the codebook to enable the receiver node to generate the coding coefficient using a locally stored codebook selected based on the index.

16. The method of claim 15, wherein communicating the signaling comprises generating a packet header that includes the index and does not include the coding coefficient.

17. The method of claim 16, wherein generating the packet header comprises generating the packet header including an indication of batch size.

18. The method of claim 16, wherein generating the packet header comprises generating the packet header including an indication of a feedback threshold defining a threshold number of error packets.

19. The method of claim 16, wherein generating the packet header comprises generating the packet header including an indication of a termination for a current network coding batch.

20. The method of claim 15, wherein the codebook comprises a number of coding coefficients at least equal to a number of packets encoded.

21. The method of claim 20, wherein the codebook comprises a number of additional coefficients for redundancy.

22. An apparatus comprising a processor configured to:
utilize a coding coefficient for network coding of signaling to be sent from a transmitter node to a receiver node, the coding coefficient corresponding to a codebook accessible to the transmitter node; and
communicate the signaling to the receiver node along with an index of the codebook to enable the receiver node to generate the coding coefficient using a locally stored codebook selected based on the index.

23. The apparatus of claim 22, wherein the processor being configured to communicate the signaling comprises the processor being configured to generate a packet header that includes the index and does not include the coding coefficient.

24. The apparatus of claim 23, wherein the processor being configured to generate the packet header comprises the processor being configured to generate the packet header including an indication of batch size.

25. The apparatus of claim 23, wherein the processor being configured to generate the packet header comprises the processor being configured to generate the packet header including an indication of a feedback threshold defining a threshold number of error packets.

26. The apparatus of claim 23, wherein the processor being configured to generate the packet header comprises the processor being configured to generate the packet header including an indication of a termination for a current network coding batch.

27. The apparatus of claim 22, wherein the codebook comprises a number of coding coefficients at least equal to a number of packets encoded.

28. The apparatus of claim 27, wherein the codebook comprises a number of additional coefficients for redundancy.
